(19) United States
(12) Patent Application Publication
(10) Pub. No.: US 2025/0048060 A1
(43) Pub. Date: Feb. 6, 2025

(54) TRACKING METHOD AND APPARATUS FOR A TRANSPORTATION NETWORK

(71) Applicant: HITACHI RAIL STS S.P.A., NAPOLI (IT)

(72) Inventors: Leonardo IMPAGLIAZZO, NAPOLI (IT); Carmine STRIGARGO, NAPOLI (IT); Bibiana CASCELLI, NAPOLI (IT); Davide NARDONE, NAPOLI (IT)

(21) Appl. No.: 18/713,489

(22) PCT Filed: Nov. 17, 2022
(86) PCT No.: PCT/IB2022/061084

§ 371 Date: May 24, 2024

(30) Foreign Application Priority Data
Nov. 26, 2021 (IT) 102021000029960

(51) Int. Cl. H04W 4/029

(52) U.S. Cl. CPC H04W 4/029

(57) ABSTRACT

A method and a user equipment for tracking a second user equipment in a transportation network is described. The user equipment is configured for receiving a first identification signal having a first identification datum, emitted by the second user equipment when it is aboard a means of transportation, determining a position datum that defines the position in which the first identification signal has been received, and transmitting a second identification signal to an electronic computer. The second identification signal has the first identification datum and the position datum, so that the electronic computer can track the route being followed by the second user equipment in the transportation network on the basis of the first identification datum and the position datum.

The present invention relates to a method and an apparatus for tracking a second user equipment in a transportation network, particularly in an intermodal public transportation network.

As is known, there is an increasing need for measuring and controlling the flows of people moving in a public transportation network in order to reduce the assembling of crowds in specific spots within the transportation network, such as, for example, in proximity to ticket validators or ticket vending machines, where people tend to assemble for validating or buying travel documents. This results in decreased efficiency of the transportation network, producing also increased carbon dioxide emissions because of the lower average speed—and reduced efficiency—of the means of transportation. In means of transportation like trams and buses, in fact, people tend to create queues (thus assembling) as they get on the means of transportation, in that many passengers must validate their tickets using a validator prior to reaching their seats, thus causing a reduction in the average speed and efficiency of the means of transportation.

The solution described in European patent application publication No. EP 3 843 028 A1 solves these problems by means of an electronic ticket vending/validating system that permits speeding up the ticket emission/validation process by using a user equipment (e.g. a smartphone, a smartwatch, or the like) configured for detecting the presence of radio transmitters (also known as “beacons”) positioned at stops and on public means of transportation for determining the position of the user of said equipment on the basis of the detected beacons, thus making it possible to determine the route being followed within the transportation network.

However, this solution has some drawbacks; in fact, the beacons are positioned in well-known spots within the network, and are therefore exposed to a high risk of acts of vandalism. Moreover, this solution turns out to be poorly fault-tolerant, because in the event of a malfunction of one or more beacons positioned at a particular stop of the transportation network, many passengers in transit from that very stop will not be detected, thus making the tracking of the users in the transportation network incomplete.

The present invention aims at solving these and other problems by providing a method for tracking a user equipment in a transportation network.

Furthermore, the present invention aims at solving these and other problems by providing also a user equipment for tracking a second user equipment in a transportation network.

The basic idea of the present invention is to configure a user equipment (e.g. a smartphone, a smartwatch, a tablet, or the like) or an in-vehicle apparatus situated in a means of transportation in such a way as to execute the following steps:
receiving a first identification signal emitted by said second user equipment when it is aboard said means of transportation, wherein said first identification signal comprises a first identification datum (ID1) that identifies said second user equipment;
determining, via the positioning means, a position datum that defines the position in which said first identification signal has been received;
transmitting a second identification signal to an electronic computer, wherein said second identification signal comprises at least said first identification datum and said position datum.

This allows an electronic computer to know the position of the second user equipment, and hence to track the route being followed by the second user equipment within the transportation network, even when said second user equipment is unable to communicate with said electronic computer, e.g. because the data connection has been disabled or has not been configured, or because the data network is not available on a specific band or not accessible due to an excessively large number of user equipments within a given area, etc.

Further advantageous features of the present invention will be set out in the appended claims.

These features as well as further advantages of the present invention will become more apparent in the light of the following description of a preferred embodiment thereof as shown in the annexed drawings, which are provided herein merely by way of non-limiting example, wherein:

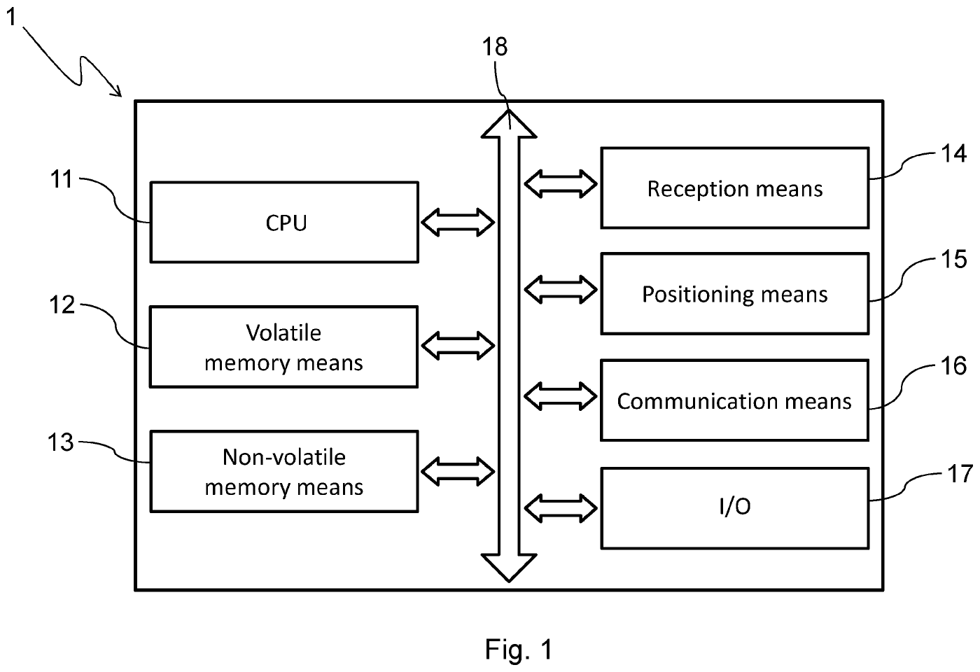

FIG. 1 shows a block diagram of a user equipment according to the invention;

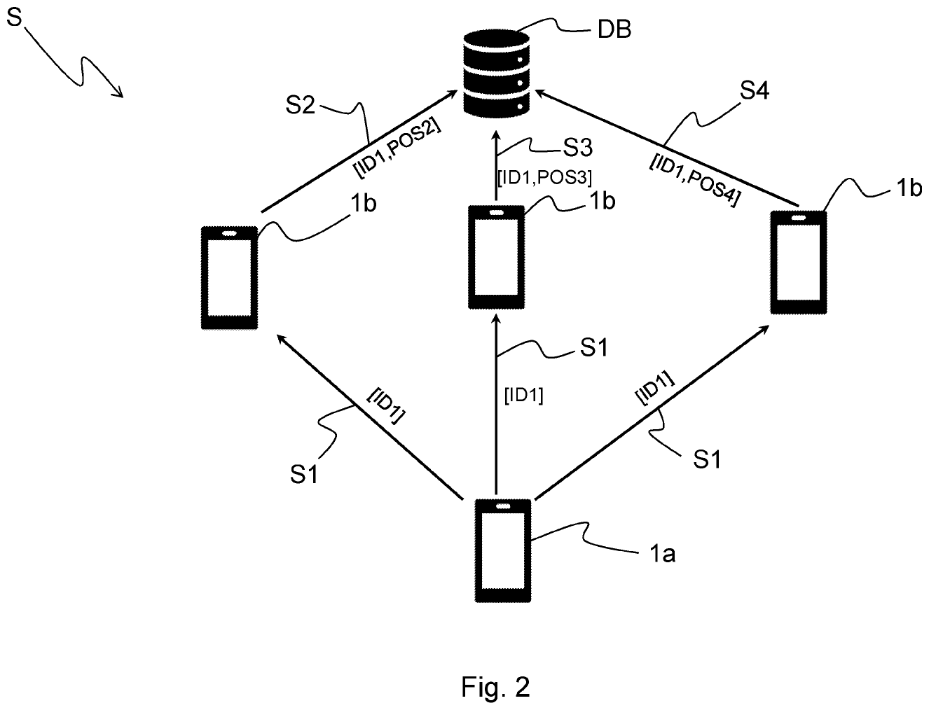

FIG. 2 shows a tracking system comprising a plurality of user equipments like the one of FIG. 1;

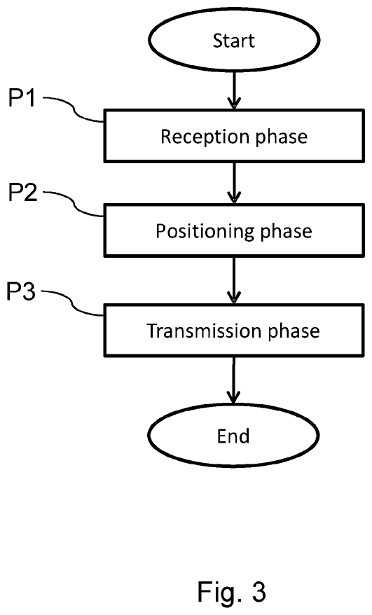

FIG. 3 shows a flow chart representing a method according to the invention;

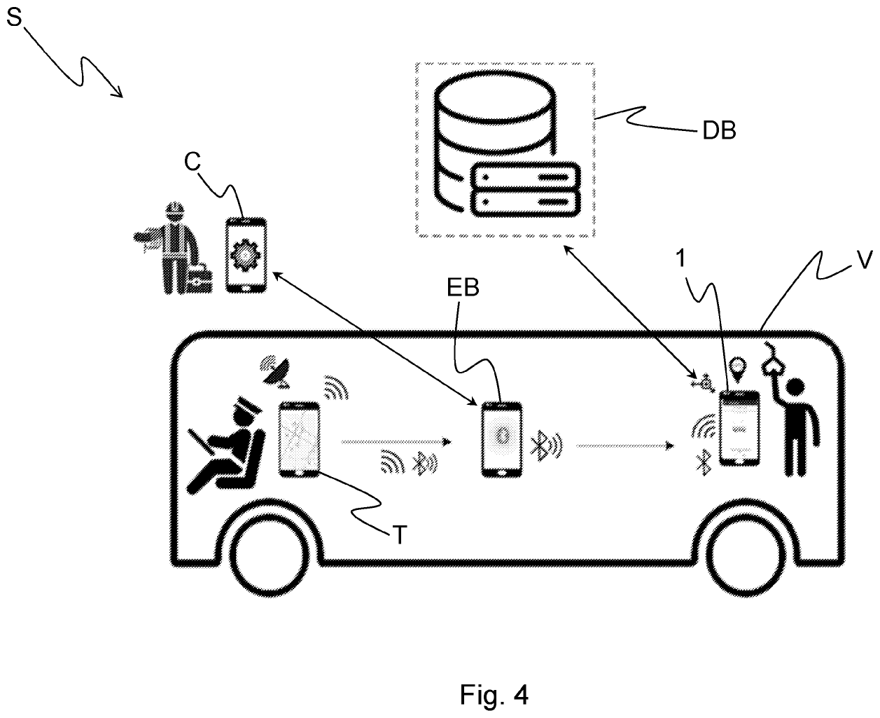

FIG. 4 shows a preferred embodiment of the tracking system of FIG. 2.

In this description, any reference to “an embodiment” will indicate that a particular configuration, structure or feature is comprised in at least one embodiment of the invention. Therefore, expressions such as “in an embodiment” and the like, which may be found in different parts of this description, will not necessarily refer to the same embodiment. Moreover, any particular configuration, structure or feature may be combined as deemed appropriate in one or more embodiments. The references below are therefore used only for simplicity's sake, and shall not limit the protection scope or extension of the various embodiments.

With reference to FIG. 1, the following will describe an embodiment of a user equipment 1 (e.g. a smartphone, a smartwatch, a tablet, or the like) according to the invention, wherein said user equipment 1 can track a second user equipment in a transportation network, preferably a public urban or suburban transportation network.

The user equipment 1 according to the invention comprises the following components:
processing and/or control means 11, e.g. one or more CPUs, which control the operation of the user equipment 1, preferably in a programmable manner, through the execution of suitable instructions;
volatile memory means 12, e.g. a random access memory RAM, in signal communication with the processing and/or control means 11, wherein said volatile memory means 12 store at least instructions that can be read by the processing and/or control means 11 when the user equipment 1 is in an operating condition;
non-volatile memory means 13, preferably a Flash memory or the like, in signal communication with the processing and/or control means 11 and with the volatile memory means 12, wherein said memory means 13 store a set of instructions implementing at least a method for tracking a second user equipment transportation network according to the invention;
reception means 14 configured for receiving a first identification signal emitted by said second user equipment when it is aboard a means of transportation (e.g. a bus, a tram, a train, or the like), wherein said first identification signal comprises a first identification datum (e.g. an ID specially generated by using a pseudo-random numerical sequence generator, a MAC address, or the like) which identifies said second user equipment (1,1a); such reception means 14 will be described in further detail hereinafter;
positioning means 15 (e.g. a GNSS receiver or another positioning system, such as, for example, a WiFi™ or Bluetooth™ indoor positioning system, base stations of a cellular network, or the like) that can be configured for determining position data (e.g. a pair of fixed-precision decimal numbers), which define a position in which the reception means 14 have received said first identification signal;
communication means 16, preferably a network interface operating in accordance with a standard of the IEEE 803.2 family (also known as Ethernet) or the 802.11 family (also known as WiFi™) or the 802.16 family (also known as WiMax™) or an interface to a data network of the GSM™/GPRS™/UMTS™/LTE™ or TETRA™ type, or the like, which allow the user equipment 1 to communicate with other devices through a data network, the latter being described in further detail hereinafter;
input/output (I/O) means 17, which can be used, for example, for connecting to said user equipment 1 a number of peripherals (e.g. a MEMS accelerometer/gyroscope/compass, one or more interfaces allowing access to other storage means, so as to permit, preferably, copying information from the latter to the non-volatile memory means 13, or the like), or a programming terminal configured for writing instructions (which the processing and control means 11 will have to execute) into the memory means 12, 13; such input/output means 17 may comprise, for example, a USB, Firewire, RS232, IEEE 1284, etc. adapter;
a communication bus 18 allowing information to be exchanged among the processing and control means 11, the volatile memory means 12, the non-volatile memory means 13, the positioning means 15, the communication means 16 and the input/output (I/O) means 17.

As an alternative to the communication bus 18, the processing and control means 11, the volatile memory means 12, the non-volatile memory means 13, the reception means 14, the positioning means 15, the communication means 16, and the input/output (I/O) means 17 may be connected by means of a star architecture.

It must be highlighted that the first and second user equipments are preferably similar to each other.

Also with reference to FIG. 2, a tracking system S comprises a plurality of user equipments 1 like the one described above (designated as “1a” and “1b”) and an electronic computer DB, which will be described below.

Also with reference to FIG. 3, the following will describe the operation of the equipment 1 when it is in an operating condition.

When the user equipment 1 (also identified as “1b”) is in an operating condition, the processing and/or control means 11 of said user equipment 1b execute a set of instructions implementing the method for tracking a second user equipment 1a in a transportation network; such method comprises the following phases:
a reception phase (P1), wherein the first identification signal S1 emitted by the second user equipment 1a when it is aboard a means of transportation is received by the reception means 14, wherein said first identification signal comprises a first identification datum ID1 that identifies said second user equipment 1a;
a positioning phase P2, wherein a position datum POS2, POS3, POS4 is determined by the positioning means 15, and said position datum defines the position in which the reception means 14 of said user equipment 1b have received said first identification signal ID1;
a transmission phase P3, wherein a second identification signal S2, S3, S4 is transmitted, by the communication means 16, to an electronic computer DB, wherein said second identification signal comprises at least said first identification datum ID1 and said position datum POS2, POS3, POS4, so that said electronic computer DB can, as will be further described hereinafter, track the route being followed by said second user equipment 1a in said transportation network on the basis of at least said first identification datum ID1 and said position datum POS2, POS3, POS4.

This allows an electronic computer to know the position of the second user equipment, and hence to track the route being followed by the second user equipment 1a within the transportation network, even when said second user equipment 1a is unable to communicate with said electronic computer DB.

The reception means 14 preferably comprise a wireless data interface such as, for example, a Bluetooth™ or WiFi™ data interface; in addition, it must be pointed out that such wireless data interface may also be comprised in the positioning means 15.

The electronic computer DB preferably comprises two or more servers connected to each other to form a cluster; said electronic computer DB is preferably configured for executing a set of instructions implementing a DBMS (Data Base Management System), which permits organizing the data received from the user equipments 1b so as to ensure that such data can be accessed efficiently. Moreover, said electronic computer DB is also configured for executing a set of instructions implementing a tracking algorithm adapted to determine, on the basis of one or more position data determined and transmitted by one or more of said user equipments 1b, a route datum that defines a route that the second equipment 1a has followed within the transportation network. This set of instructions preferably implements a neural network trained by inputting to said neural network at least one sequence of position data and by forcing it to output at least one route datum compatible with the input sequence of position data, wherein the term “compatible” indicates that the data sequence inputted to the neural network could be generated by a user equipment which has (actually) followed the route defined by the route datum forcedly outputted by said neural network. This increases noise immunity (which noise may enter the system during the positioning phase P2) of the tracking process executed by the electronic computer DB.

In this way, it is possible to track the route being followed by the second user equipment 1a in the transportation network with a higher level of accuracy.

As can be understood from FIG. 3, the method according to the invention can be executed simultaneously by a plurality of user equipments 1b, thus advantageously making it possible to obtain position data concerning the second user equipment 1a from multiple user equipments 1b. In this manner, the electronic computer DB can track the route of the second user equipment 1a within the transportation network with greater accuracy, thereby reducing the risk that said second equipment 1a is not detected or is wrongly detected, e.g. when the user of said equipment is waiting at a stop and detected aboard a bus or a tram.

Also with reference to FIG. 4, the following will describe the preferred embodiment of the tracking system S.

In more detail, the system S preferably comprises also a transmitter apparatus EB positioned on a (public) transportation vehicle V and comprising a radio transmitter, preferably of the Bluetooth™ or WiFi™ type, which transmits an in-vehicle signal comprising trip data concerning a service provided by the transportation vehicle V, such for as, example, data representing a position (e.g. latitude and longitude) in which said transportation vehicle V is located and/or identifying, preferably in alphanumerical format, the line on which said vehicle is providing service and/or one or more stops where the vehicle V has already stopped and/or will have to stop; said transmitter apparatus EB may be a smartphone, a tablet, an industrial PC (equipped with a Bluetooth™ or WiFi™ interface), or another type of device suitable for being positioned on a transportation vehicle V.

The positioning signal can be received by the positioning means 15 of the user equipment 1. For this purpose, the positioning means 15 preferably comprise a radio receiver/transceiver, preferably of the Bluetooth™ type, and the processing and/or control means 11 are preferably configured for determining the position datum (during the positioning phase P2) by executing the following steps:
receiving, via the radio receiver, the in-vehicle signal emitted by the transmitter apparatus EB;
determining the position datum on the basis of the trip data comprised in said in-vehicle signal, e.g. by reading the latitude and longitude data (if available) or by retrieving from the Internet the position of a given stop or the route (or part thereof) of the line whereon the transportation vehicle V is providing service.

This allows the user equipment 1 to determine its own position even when it is unable to do so autonomously, e.g. due to the impossibility of seeing the sky or receiving the signal of at least one base station of a cellular network, or because said user equipment 1 wants to reduce its power consumption, or the like. This situation occurs very often when travelling along underground tunnels lacking proper communication equipment, where the GNSS receiver and/or the communication means 16 cannot be used for establishing the position of the user equipment. The electronic computer DB can thus come to know the position of a user equipment 1a which is unable to communicate with the electronic computer DB, and hence can track the route being followed by said user equipment 1a in the transportation network even when said user equipment 1a cannot communicate with said electronic computer DB and the other user equipments 1b are unable to autonomously determine their own position.

Furthermore, the radio receiver comprised in the positioning means 15 may be of the Bluetooth™ Low Energy (BLE) type; such a radio receiver has the advantage that it requires no pairing procedure, and hence no user action, thus facilitating the operation of the system S.

In combination with or as an alternative to the above, the radio transceiver comprised in the positioning means 15 may be of the WiFi™ and/or Bluetooth™ Low Energy type, i.e. it can establish a connection with the transmitter apparatus EB. In other words, the processing and/or control means 11 are preferably also configured for establishing a connection with the transmitter apparatus EB prior to receiving the in-vehicle signal emitted by said transmitter apparatus EB, and for keeping said connection alive (e.g. by repeatedly sending messages via the Bluetooth™ Low Energy interface) after having determined the position datum. This allows the transmitter apparatus EB to constantly know the number of user equipments 1a, 1b actually connected to it, so that it can compare such number with the number of people actually aboard; as a matter of fact, the number of people can preferably be measured using well-known solutions (e.g. surveillance cameras connected to a computer running an algorithm capable of counting the number of people getting on and off the vehicle V), so that it is possible to know whether all passengers have their user equipments 1a, 1b active and configured to permit tracking within the transportation network, and, if there are any untracked passengers, to invite such passengers to activate the specific application on their user equipment 1a, 1b (i.e. to properly configure their user equipment 1a, 1b), e.g. by playing an audio and/or video message inviting the passengers to activate the application, and signalling this situation to a driver and/or a ticket inspector, or the like.

In other words, the transmitter apparatus EB can be configured for executing the following steps:
determining a number of passengers aboard the vehicle, e.g. by acquiring such datum (e.g. via the ModBus™ protocol) from a passenger counting system aboard the vehicle V;
determining a number of user equipments 1a, 1b connected to said transmitter apparatus EB;
determining, on the basis of the number of passengers and the number of user equipments 1a, 1b connected to said transmitter apparatus EB, whether an invitation signal (e.g. an audio/video message and/or a notification for a ticket inspector and/or a driver) should be generated in order to invite the passengers to correctly configure their own user equipments 1a, 1b, so as to reduce the presence of untracked passengers.

This reduces the probability that untracked passengers are present in the transportation network. In this way, the electronic computer DB can come to know the position of a larger number of user equipments 1a, 1b, being thus able to track the route being followed by said user equipments 1a, 1b in the transportation network even when said user equipments 1a are unable to communicate with said electronic computer DB.

In combination with or as an alternative to the above, the positioning means 15 may comprise a wireless network access interface, i.e. an IEEE 802.11 (WiFi™) communication interface, wherein the memory means 12, 13 preferably contain at least coverage data associating with at least one wireless network a position or an area where it is possible to receive the signal of said wireless data network, and wherein the processing and/or control means 11 are preferably configured for determining the position datum (during the positioning phase) by executing the following steps:
determining, by means of the wireless network access interface, a set of identifiers, each one of which identifies one wireless data network, e.g. the SSID, the MAC address of an access point, or the like.
determining the position datum on the basis of said set of identifiers and the coverage data.

This allows the user equipment 1b to determine its own position at a low energetic cost, thus reducing the risk of the presence of untracked passengers in the transportation network. In this manner, the electronic computer DB can know the position of a larger number of user equipments 1a, 1b, and hence can track the route being followed by said user equipments 1a, 1b in the transportation network even when said user equipments 1a are unable to communicate with said electronic computer DB.

In combination with or as an alternative to the above, the positioning means 15 preferably comprise also a receiver of satellite positioning signals, i.e. a GNSS receiver, and the processing and/or control means 11 are preferably configured for determining the positioning data by executing the following steps:
activating the GNSS receiver;
determining, via the GNSS receiver, at least one signal-to-noise ratio of at least one positioning signal, preferably received from a positioning satellite and preferably usable for calculating the position;
determining, via the GNSS receiver, the positioning datum if said at least one signal-to-noise ratio is higher than a threshold, e.g. a threshold that ensures a positioning precision of less than 7 metres.

This solution is particularly interesting in the initial phase of deploying the tracking system C or in case of a failure of the transmitter apparatus EB, in that it ensures that the position data associated with a user equipment 1a (which is unable to communicate with the electronic computer DB) are reliable, i.e. that they have been determined by means of a GNSS receiver in satisfactory reception conditions, advantageously discarding any user equipments 1b in unfavourable reception conditions, e.g. inside a bag, near metal objects, far from windows, or the like. In this way, the electronic computer DB can know the position of a user equipment 1a, and hence track the route being followed by said user equipment 1a in the transportation network even when said user equipment 1a is unable to communicate with said electronic computer DB.

In combination with or as an alternative to the above, the user equipment 1b may comprise orientation means, e.g. a MEMS accelerometer and/or gyroscope and/or compass, configured for generating an orientation signal representing at least one orientation of the user equipment 1b and/or a movement to which said user equipment 1b is being subjected, and the processing and/or control means 11 are preferably configured for executing the following steps:
acquiring, via the input means 17, the orientation signal generated by the orientation means;
determining, on the basis of the orientation signal, a motion datum that defines whether said user equipment 1b is in a means of transportation, e.g. by executing a set of instructions implementing a neural network trained to recognize an orientation signal of a user equipment situated in a moving (public) means of transportation;
determining the position datum (only) if said motion datum indicates that the user equipment 1b is in a means of transportation.

This makes it possible to prevent any user equipments 1a, 1b that are not aboard a public means of transportation, but in the vicinity thereof (e.g. waiting at a stop, or on a pavement along a road whereon public means of transportation are travelling) from executing the method according to the invention.

In this way, the electronic computer DB can come to know the position of a user equipment 1a, and hence can track the route being followed by said user equipment 1a (which is unable to communicate with the electronic computer DB) in the transportation network only when said user equipment 1b is aboard a means of transportation, thus improving the quality of the acquired data.

In addition to the above, the system S preferably comprises also a service apparatus T (e.g. a smartphone, a smartwatch, or the like), which is preferably assigned to the driver of the vehicle V, and which executes an application that controls the operation of the transmission apparatus EB so as to ensure that the messages issued by said transmission apparatus EB will always be up-to-date and coherent with the route that the vehicle Vis about to travel or has already travelled.

In other words, the service e apparatus T is preferably configured for executing the following steps:
establishing a connection (via Bluetooth™ or WiFi™) with the transmission apparatus EB and, preferably, logging in to it; generating update data on the basis of service data specifying a status of a service that the vehicle V will have to provide or is providing, such as, for example, a line identifier, a direction of travel along said line, a current position, stops already made, stops still to be made, or the like;
transmitting, via said connection, an update message to the transmission apparatus EB, wherein said update message contains at least said update data.

In addition, the transmission apparatus EB is preferably configured for receiving said update message and for generating the trip data on the basis of said update message.

This makes it possible to constantly update the messages transmitted by the transmission apparatus EB, thus preventing the transmission apparatus EB from transmitting wrong data and the electronic computer DB from receiving wrong information; it happens quite often, in fact, that when driver changes occur, and particularly at line termini, electronic systems like the transmission apparatus EB are not updated by the driver in the vehicle V or, remotely, by the transportation network supervisor. Furthermore, this solution prevents detecting people who are aboard the vehicle V before it leaves, e.g. when the vehicle V is still waiting at the terminus prior to starting service.

In this way, the electronic computer DB can know the position of a user equipment 1a, and hence can track the route being followed by said user equipment 1a in the transportation network only when said user equipment 1b is aboard a means of transportation during its actual service, thus improving the quality of the acquired data.

Lastly, the system S preferably comprises also a maintenance apparatus C (e.g. a smartphone, a smartwatch, or the like) that allows a service technician to supervise, configure and verify the operation of the apparatus EB, e.g. when the vehicle V enters or exits a depot, so as to minimize the risk that the transmission apparatus EB is out of service and that the electronic computer DB will receive low-quality data or no data at all about the access to the vehicle V by users of the transportation network.

Of course, the example described so far may be subject to many variations.

Some of the possible variants of the invention have been described above, but it will be clear to those skilled in the art that other embodiments may also be implemented in practice, wherein several elements may be replaced with other technically equivalent elements. The present invention is not, therefore, limited to the above-described illustrative examples, but may be subject to various modifications, improvements, or replacements of equivalent parts and elements without however departing from the basic inventive idea, as specified in the following claims.

1.-15. (canceled)

16. A user equipment for tracking a second user equipment in a transportation network, comprising:
a reception means for receiving signals emitted by said second user equipment,
a positioning means for determining the position of said user equipment,
a communication means for transmitting signals to an electronic computer, and
a processing means configured for
receiving, via the reception means, a first identification signal emitted by said second user equipment when it is aboard a means of transportation, wherein said first identification signal comprises a first identification datum that identifies said second user equipment,
determining, via the positioning means, a position datum that defines the position in which said first identification signal has been received, and
transmitting, via the communication means, a second identification signal to said electronic computer, wherein said second identification signal comprises at least said first identification datum and said position datum, so that said electronic computer can track the route being followed by said second user equipment in said transportation network on the basis of at least said first identification datum and said position datum.

17. The user equipment according to claim 16, wherein the positioning means comprise a radio receiver, wherein the processing and/or control means are preferably configured for
receiving, via a radio receiver, an in-vehicle signal emitted by a transmitter apparatus positioned in said vehicle, wherein said in-vehicle signal comprises trip data that define a service provided by said transportation vehicle, and
determining the position datum on the basis of the trip data comprised in said in-vehicle signal.

18. The user equipment according to claim 17, further comprising memory means containing at least coverage data associating with at least one wireless data network a position or an area where it is possible to receive the signal of said wireless network, wherein the positioning means comprise a wireless network access interface, and wherein the processing and/or control means are configured for
determining, via said wireless network access interface, a set of identifiers, each one of which identifies one wireless data network, and
determining the position datum on the basis of said set of identifiers and said coverage data.

19. The user equipment according to claim 18, wherein the positioning means further comprise a receiver of satellite positioning signals, and wherein the processing and/or control means are configured for
activating the receiver of satellite positioning signals,
determining, via said receiver of satellite positioning signals, at least one signal-to-noise ratio of at least one positioning signal received,
determining, via said receiver of satellite positioning signals, the position datum if said at least one signal-to-noise ratio is higher than a threshold.

20. The user equipment according to claim 19, wherein the positioning means further comprise orientation means configured for generating an orientation signal representing at least one orientation of the user equipment and/or a movement to which said user equipment is being subjected, wherein said user equipment further comprises input means adapted to acquire said orientation signal, and wherein the processing and/or control means are configured for
acquiring, via the input means, the orientation signal generated by the orientation means,
determining, on the basis of the orientation signal, a motion datum that defines whether said user equipment is in a means of transportation, and
determining the position datum only if said motion datum indicates that the user equipment is in a means of transportation.

21. A tracking system comprising at least
a first user equipment according to claim 16, and
an electronic computer configured for executing a set of instructions implementing a tracking algorithm adapted to determine, on the basis of one or more position data determined and transmitted by at least said first user equipment and said first identification datum, a route datum that defines a route that the second user equipment has followed within the transportation network.

22. The tracking system according to claim 21, further comprising a transmitter apparatus positioned in said vehicle and configured for transmitting an in-vehicle signal containing at least trip data that define a service provided by said transportation vehicle, wherein the processing and/or control means of the first user equipment are also configured for establishing a connection with the transmitter apparatus prior to receiving the in-vehicle signal emitted by said transmitter apparatus, and for keeping said connection alive after having determined the position datum, and wherein the transmitter apparatus may be configured for
determining a number of passengers aboard the vehicle,
determining a number of user equipments connected to said transmitter apparatus (EB), and
determining, on the basis of the number of passengers and the number of user equipments connected to said transmitter apparatus, whether an invitation signal should be generated in order to invite the passengers to correctly configure their own user equipment (1a, 1b), so as to reduce the presence of untracked passengers.

23. The tracking system according to claim 22, comprising a service apparatus configured for
establishing a connection with the transmission apparatus,
generating update data on the basis of service data specifying a status of a service that the vehicle will have to provide or is providing, and
transmitting, via said connection, an update message to the transmission apparatus, wherein said update message contains at least said update data, and wherein
said transmission apparatus is configured for
receiving said update message, and
generating the trip data on the basis of said update message.

24. The tracking system according to claim 23, wherein the set of instructions executed by the electronic computer implements a neural network trained by inputting to said neural network at least one sequence of position data and by forcing it to output at least one second route datum compatible with the input sequence of position data.

25. A method for tracking a first user equipment in a transportation network, comprising:
a reception phase, wherein a first identification signal emitted by said first user equipment when it is aboard a means of transportation is received by reception means, wherein said first identification signal comprises a first identification datum that identifies said first user equipment,
a positioning phase, wherein a position datum is determined by positioning means, and said position datum defines the position in which said first identification signal has been received,
a transmission phase, wherein a second identification signal is transmitted, by communication means, to an electronic computer, wherein said second identification signal comprises at least said first identification datum and said position datum, so that said electronic computer can track the route being followed by said first user equipment in said transportation network on the basis of at least said first identification datum and said position datum.

26. The method according to claim 25, wherein, during the positioning phase, the following steps are carried out:
receiving, via a radio receiver comprised in the positioning means, an in-vehicle signal emitted by a transmitter apparatus positioned in said vehicle, wherein said in-vehicle signal comprises trip data that define a service provided by said transportation vehicle, and
determining the position datum on the basis of the trip data comprised in said in-vehicle signal.

27. The method according to claim 26, wherein, during the positioning phase, the following steps are carried out:
determining, via a wireless network access interface, a set of identifiers, each one of which identifies one wireless data network, and
determining the position datum on the basis of said set of identifiers and coverage data, wherein said coverage data associate with at least one wireless data network a position or an area in which it is possible to receive the signal of said wireless data network.

28. The method according to claim 27, wherein, during the positioning phase, the following steps are carried out:
activating a receiver of satellite positioning signals comprised in the positioning means,
determining, via said receiver of satellite positioning signals, at least one signal-to-noise ratio of at least one positioning signal received,
determining, via said receiver of satellite positioning signals, the position datum if said at least one signal-to-noise ratio is higher than a threshold.

29. The method according to claim 28, wherein, during the positioning phase, the following steps are carried out:
acquiring, via input means, an orientation signal generated by orientation means, wherein said orientation signal represents at least one orientation of a second user equipment and/or a movement to which said second user equipment is being subjected,
determining, on the basis of the orientation signal, a motion datum that defines whether said second user equipment is in a means of transportation, and
determining the position datum only if said motion datum indicates that the user equipment is in a means of transportation.

30. A computer program product loadable into the memory of an electronic computer and comprising software code portions for the execution of the phases of the method according to claim 29.
